(19) United States
(12) Patent Application Publication
(10) Pub. No.: US 2014/0014452 A1
(43) Pub. Date: Jan. 16, 2014

(54) Device to Protect Vehicles in Event of Collision With Obsticles

(71) Applicants: William O. Eckhardt, Farmington, UT (US); Bryan Sylvester, Taylorsville, UT (US)

(72) Inventors: William O. Eckhardt, Farmington, UT (US); Bryan Sylvester, Taylorsville, UT (US)

(21) Appl. No.: 13/735,984

(22) Filed: Jan. 7, 2013

Related U.S. Application Data
(60) Provisional application No. 61/583,277, filed on Jan. 5, 2012.

(51) Int. Cl. E01F 15/14; F16F 7/12

(52) U.S. Cl. CPC E01F 15/141; F16F 7/12
USPC 188/377; 29/428

(57) ABSTRACT

A protective device for securement to a hard surface to soften an impact of a vehicle against the surface includes a shock absorbing material forming a device core and a flexible membrane coating the shock absorbing material to enclose the shock absorbing material and provide a substantially soft, non-scratching surface. The core may be a foam material such as a polystyrene foam or a polyethylene foam. The membrane may be an aliphatic acrylic polyurethane material applied over the core. The device can take may shapes depending upon the shape of the surface on which it is to be mounted. An L shaped device can be mounted over a right angle wall or pillar corner, a portion of a ring, such as a semicircle, can be mounted over a round pillar, and a flat device can be mounted on a flat wall.

### PRIORITY CLAIM Priority is claimed to copending U.S. Provisional Patent Application Ser. No. 61/583,277 filed Jan. 5, 2012, which is hereby incorporated herein by reference in its entirety.

### BACKGROUND OF THE INVENTION

1. Field of the Invention

The present invention relates generally to protectors to protect vehicles from damage due to hitting or scraping pillars, walls, or other obstructions, particularly in parking garages.

2. Related Art

Parking garages, particularly multistory or underground parking garages, usually include supporting pillars, generally of concrete and sometimes of steel or other materials, and walls, generally of concrete. These pillars and walls present a hazard to vehicles being parked in such a garage because such vehicles can hit or scrape the pillars or walls causing damage to the vehicles. This is a particular problem in garages with parking attendants or valets who park the vehicles making the garage owners or operators liable for any damage done to the vehicles during parking by the attendant or valet. While it is difficult to prevent such collisions and scrapes with pillars or walls, it is desirable to eliminate or reduce damage to the vehicles from such collisions or scrapes.

Several protection devices have been disclosed in the prior art. Such devices provide blankets or pads to be wrapped around a pillar to provide a shock absorbing surface when hit by a vehicle. For example, substantially rigid sheets of a plastic foam material such as polyether or polyurethane foam material may be adhesively secured in a spaced arrangement to a flexible sheet of sailcloth. The flexible sailcloth is then wrapped around a polygonal pillar with the attached pieces of foam sheet material held against each of the polygonal surfaces by the flexible sailcloth forming a sleeve. The ends of the sailcloth are joined to form the sleeve. The sailcloth may be plasticized with a flexible layer of polyvinyl chloride on one or both sides. (See U.S. Published Application US 2007/0036938). Alternately, a sheet of flexible elastomeric material is adhesively secured to a flexible piece of canvas which is wrapped around a pillar and ends of the canvas joined to form a sleeve around the pillar. (See U.S. Published Application US 2008/0202044).

The need still remains for an easy to use and effective protection for vehicles against damage when hitting a pillar, wall, or similar item.

### SUMMARY OF THE INVENTION

According to the invention, a protective device for securement to a hard surface, such as a concrete pillar or concrete wall in a parking garage, to soften an impact of a vehicle against the hard surface to eliminate or lessen damage to the vehicle, includes a shock absorbing material, such as a foam material, forming a device core, and a flexible membrane coating the shock absorbing material. The membrane bonds to and surrounds the shock absorbing material and holds it together where it might otherwise break apart under impact. The membrane also forms a substantially soft, non-scratching outer surface for the device to further resist scratching and damaging of a vehicle impacting the device.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a corner protection device in accordance with an embodiment of the present invention showing the outer surface of the device;

FIG. 2 is a perspective view of the corner protection device shown in FIG. 1 showing the inner surface of the device;

FIG. 3 is a top plan view of the device of FIGS. 1 and 2;

FIG. 4 is a transverse section of the device of the prior Figs;

FIG. 5 is a perspective view showing the device of the prior Figs. mounted to a corner of a wall;

FIG. 6 is a top plan view showing two devices of the prior Figs. mounted to two corners of a pillar;

FIG. 7 is a transverse section similar to that shown in FIG. 4;

FIG. 8 is a side elevation of the device of FIG. 7;

FIG. 9 is transverse section of another embodiment of the device;

FIG. 10 is a perspective view of the device of FIG. 9;

FIG. 11 is transverse section of another embodiment of the device; and

FIG. 12 is a side elevation of the device of FIG. 11.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

The invention provides a protective device for securement to a hard surface to soften an impact of a vehicle against the surface. The hard surface may be a corner of a wall or a corner of a pillar in a parking garage, a round pillar in a parking garage, or may be a flat wall or other obstruction in a parking garage. The purpose of the invention is to eliminate or limit the damage occurring to the vehicle as a result of the impact of the vehicle against the hard surface. The device of the invention can take various forms depending upon the configuration of the particular surface to which the device is to be secured. The device provides a shock absorbing material and a membrane coating the shock absorbing material to provide the surface with which the vehicle comes into contact.

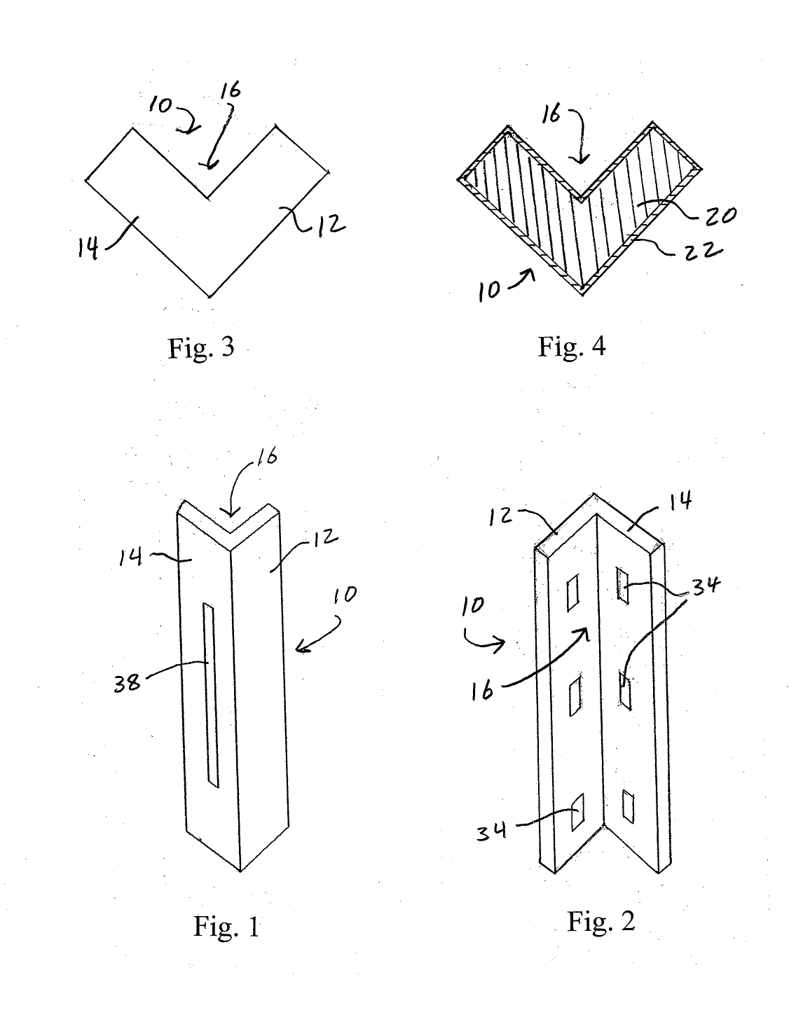

FIGS. 1-8 show an embodiment of the device 10 for use on corners to protect a vehicle coming into contact with such corners. The corner device 10 illustrated is L shaped having legs 12 and 14 extending at substantially right angles to one another to form an inner corner receiving space 16 at the intersection of the legs 12 and 14. An inner core 20, FIGS. 4 and 7, is formed of a shock absorbing material and an outer membrane 22 coats and encloses the inner core 20. The inner core 20 can be formed of a single piece of material or can be formed of several pieces bonded together, such as by glue. With the L shape shown, the core can be a single integral piece or the legs 12 and 14 can be formed by separate pieces with either flat or mitered abutting surfaces. The membrane can be applied to the core in various ways, such as by painting or spraying membrane material in liquid form onto the core, or by dipping the core into liquid membrane material, and then allowing the membrane material to harden or cure onto the core.

Various shock absorbing materials can be used for the shock absorbing inner core 20. Polystyrene foam material, such as expanded polystyrene and STYROFOAM, for example white STYROFOAM, and polyethylene foam have been found satisfactory. The important properties of the shock absorbing inner core material is that it can absorb the impact of a vehicle against a hard surface at a vehicle speed typical during parking maneuvers in a tight space. Such speed is generally below about ten miles per hour and usually approximately five miles per hour. Similarly, various materials can be used for the membrane 22 coating the inner core 20. A coating of aliphatic acrylic polyurethane applied directly to the outside surfaces of the inner core 20 so as to enclose the inner core 20 has been found satisfactory. An acrylic-reinforced aliphatic aromatic polyurethane has been found to work well. The important properties of the membrane material is that it is flexible, and remains flexible in cold weather expected in the location where used, will stretch, is tear and crack resistant, and is bonded to the core material to counteract any tendency of the core to break apart during impact of a vehicle. It also provides a non-scratching surface against which the vehicle will impact.

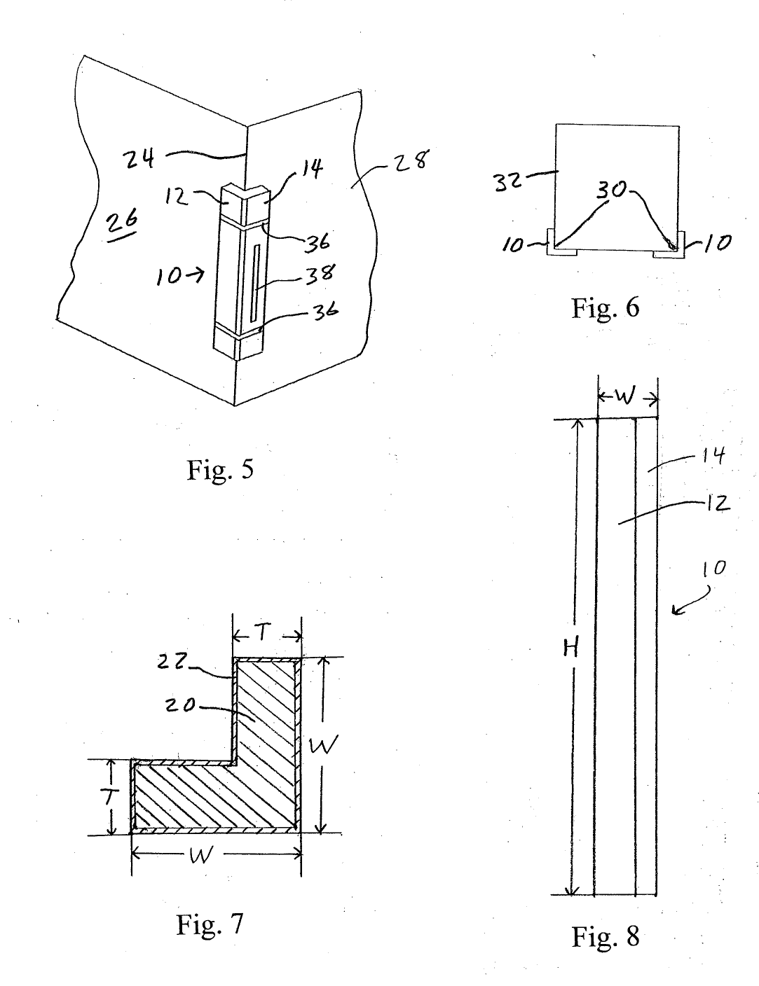

As shown in FIG. 5, a corner device 10 of the invention can be positioned along a corner 24 joining two walls 26 and 28, or as shown in FIG. 6, can be positioned along one or more (two being shown) corners 30 of a pillar 32, to protect a vehicle that might hit such a corner during parking maneuvers and be damaged thereby except for the presence of the protective device along the corner. The corner 24 for which protection is desired is received in the inner corner receiving space 16 of the L shaped corner device 10, with device legs 12 and 14 extending along respective walls 26 and 28 adjacent the corner 24. The legs 12 and 14 will generally be connected to form a ninety degree corner. The protective corner device 10 would extend along the corner at a height and for a distance to cover the locations of the corner that could be hit by a vehicle during parking maneuvers. Typical satisfactory dimensions are about four to five feet in height, H, and about six to ten inches in width, W, with each leg being about two to four inches in thickness, T, as indicated on FIGS. 7 and 8. This indicated thickness of foam provides a good balance between protection and profile, meaning thick enough to help prevent damage to cars and structure in the event of a normal speed parking situation, yet trim enough to allow easy access to parking stalls without taking up room. The flexible membrane is approximately 0.125 to 0.25 inches in thickness, and provides enough coverage to the foam that should an accident occur, it will not rip, tear, or otherwise fail. However, the measurements may vary over a wide range.

The protective corner device 10 can be secured to a corner in various ways. For example, the corner device can be glued, such as with construction adhesive, to the walls forming the corner, can be secured with heavy-duty double-sided pressure sensitive adhesive foam tape 34, FIG. 2, or can be otherwise secured, such as by straps 36, FIG. 5. Rather than forming the sole means of mounting, the pressure sensitive adhesive foam tape 34 can be used to hold the device in desired position while applying other mounting means, such as the straps 36 of FIG. 5. When using straps, an end of each of a pair of straps can be secured to the walls or pillars on opposite sides of the corner, such as by concrete screws, and the straps secured across the corner device by mating buckles on opposite ends of each of the straps.

The membrane can be of various colors. It has been found advantageous to make the membrane of a bright color, such as yellow, which can be easily seen under various lighting conditions. Also, if desired, a reflective strip 38, FIGS. 1 and 5, can be mounted on the device. For example, reflective strips of from about ten to twenty four inches can be installed on the most visible edges of the device.

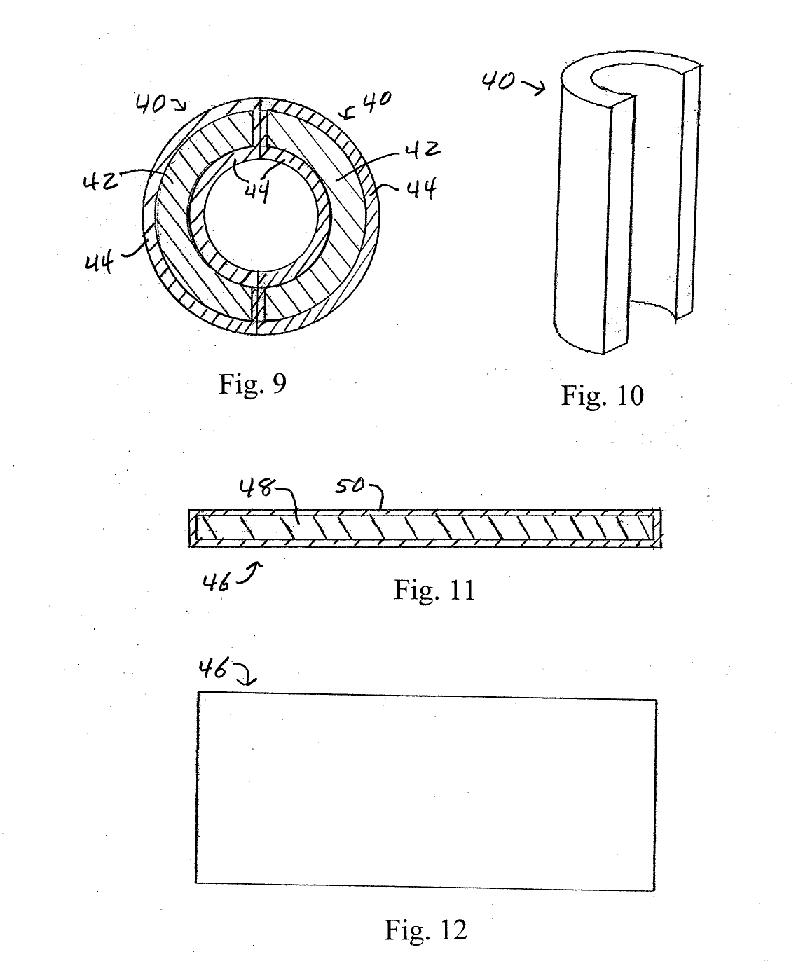

The device of the invention can be formed in many shapes and sizes to fit various obstacles. For example, FIGS. 9 and 10 show devices 40 of the invention in the form of half rings for use with circular pillars. As shown in FIG. 9, two devices 40 can be arranged to surround a circular pillar. Such devices 40 include a core, here shown as core 42, and a membrane, here shown as membrane 44, as shown and described for the corner device 10 of FIGS. 1-8. The foam material may typically be about two to four inches in thickness with a membrane coating approximately 0.125 to 0.25 in thickness.

FIGS. 11 and 12 show devices 46 of the invention in the form of a flat sheet that can be mounted on a flat wall, such as a concrete wall at the end of a parking stall, into which the front or rear of a vehicle can be bumped if the driver of the vehicle does not stop in time. Again, as shown by the section of FIG. 11, devices 46 include a core 48 and a surrounding membrane 50 as previously described. These flat sheet bumper guards may typically be about four feet in length, twelve to eighteen in width and two to four inches in thickness. The design is intended to protect bumpers and fenders from damage in the event of a normal speed parking situation against a flat wall. Again, the membrane is approximately 0.125 to 0.25 in thickness and provides enough coverage to the foam that should an accident occur, it will not rip, tear, or otherwise fail. However, the measurements may vary over a wide range.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A protective device for securement to a hard surface to soften an impact of a vehicle against the surface, comprising:
a shock absorbing material;
a flexible membrane coating the shock absorbing material to enclose the shock absorbing material and provide a substantially soft, non-scratching surface.

2. A protective device in accordance with claim 1, wherein the shock absorbing material is polystyrene foam.

3. A protective device in accordance with claim 2, wherein the shock absorbing polystyrene foam is white STYROFOAM.

4. A protective device in accordance with claim 2, wherein the flexible membrane is aliphatic acrylic polyurethane.

5. A protective device in accordance with claim 4, wherein the aliphatic acrylic polyurethane is an acrylic-reinforced aliphatic aromatic polyurethane.

6. A protective device in accordance with claim 1, wherein the shock absorbing material is polyethylene foam.

7. A protective device in accordance with claim 6, wherein the flexible membrane is aliphatic acrylic polyurethane.

8. A protective device in accordance with claim 7, wherein the aliphatic acrylic polyurethane is an acrylic-reinforced aliphatic aromatic polyurethane.

9. A protective device in accordance with claim 1, wherein the flexible membrane is aliphatic acrylic polyurethane.

10. A protective device in accordance with claim 9, wherein the aliphatic acrylic polyurethane is an acrylic-reinforced aliphatic aromatic polyurethane.

11. A protective device in accordance with claim 1, further comprising pressure sensitive adhesive for attaching the protective device to the hard surface.

12. A protective device in accordance with claim 1, further comprising reflective material.

13. A protective device in accordance with claim 1, wherein the device is adapted to fit over an approximately ninety degree corner of a hard surface, and wherein the shock absorbing material is substantially L shaped having an inside corner to fit over the approximately ninety degree corner of the hard surface.

14. A protective device in accordance with claim 13, further comprising pressure sensitive adhesive positioned on the protective device for attaching the protective device to the hard surface.

15. A protective device in accordance with claim 1, wherein the flexible membrane is yellow in color.

16. A protective device in accordance with claim 1, wherein the device is adapted to fit over a portion of a circular hard surface, and wherein the shock absorbing material is substantially semicircular in shaped to fit over the portion of the circular hard surface.

17. A protective device in accordance with claim 1, wherein the device is adapted to fit over a portion of a substantially flat hard surface, and wherein the shock absorbing material is in the form of a substantially flat sheet.

18. A method for protecting a vehicle against damage when hitting a hard surface at a typical parking speed in a tight parking location, comprising the steps of:
obtaining a protective device configured to fit over the hard surface and comprising a shock absorbing material and a flexible membrane coating the shock absorbing material to enclose the shock absorbing material and provide a substantially soft, non-scratching surface; and
securing the protective device over the hard surface.
